(19) United States
(12) Patent Application Publication
(10) Pub. No.: US 2006/0008277 A1
(43) Pub. Date: Jan. 12, 2006

(54) Optical communication system and receiving apparatus

(75) Inventor: Keisuke Noda, Shizuoka (JP)

Correspondence Address: FRISHAUF, HOLTZ, GOODMAN & CHICK, PC, 220 5TH AVE FL 16, NEW YORK, NY, 10001-7708, US

(73) Assignee: Toshiba Tec Kabushiki Kaisha, Tokyo (JP)

(21) Appl. No.: 11/175,820

(22) Filed: Jul. 6, 2005

(30) Foreign Application Priority Data
Jul. 12, 2004 (JP) 2004-204491

(51) Int. Cl. H04B 10/00

(52) U.S. Cl. 398/171

(57) ABSTRACT

A transmitting apparatus has a light source, and a receiving apparatus has a solar battery for converting optical energy into electrical energy to power the receiving apparatus. The transmitting apparatus converts digital data into an optical signal and transmits the optical signal by using the light source. The receiving apparatus converts the optical signal back into the digital data based on an amount of electricity generated in accordance with the optical signal received by the solar battery.

### CROSS-REFERENCE TO RELATED APPLICATION

The present application is based on and claims the benefit of priority of Japanese Patent Application P2004-2044.91 filed on Jul. 12, 2004, the entire contents of which are incorporated herein by reference.

### BACKGROUND OF THE INVENTION

1. Field of the Invention

The present invention relates to an optical communication system and a receiving apparatus.

2. Description of Related Art

An inventory tag is set to a shelf in a supermarket or a convenience store, and the inventory tag corresponds to a commodity displayed in the shelf. Customers can see easily the name of the commodity, a unit price, the amount, special sale information and so on, on the inventory tag. In general, a card-type inventory tag made of paper or other materials is used as the inventory tag, and the information such as the name of the commodity, the unit price and so on are printed on the inventory tag by a printer.

If this inventory tag is used, when the unit price needs to be changed for a next day sale, a shop assistant has to change the tag corresponding to the commodity for the next day sale after the shop is closed. Thus, if there are a large number of changes, it is time-consuming and it requires a large amount of work. Further, if a special sale is taking place only in a particular time, and many commodities are on sale, it would be difficult to deal with all the necessary changes within a limited time. Further, when significant changes to displays take place at different seasons of a year, many inventory tags need to be changed, and a similar problem would occur.

Consequently, to cope with such problems, an electronic inventory tag system has been developed, which uses an electronic inventory tag as the inventory tag to electronically rewrite commodity data.

The electronic inventory tag used in the electronic inventory tag system includes a liquid crystal display, a data receiving section for receiving data from a host machine, a solar battery, and so on. The electronic inventory tag is driven by electric power generated by the solar battery, and changes the unit price displayed in the liquid crystal display based on a signal received from the host machine by radio communication and/or infrared data communication.

As the host machine, a host computer located in a back of a store, for example, can be used. The host computer transmits the signal such as a change of the unit price to the electronic inventory tag(s). In this case, a plurality of radio communication apparatuses which are connected to the host computer are located on the ceilings of sales rooms so that the host computer executes radio communication with the electronic inventory tag(s) through these radio communication apparatuses.

A hand terminal can be another example of the host machine, as disclosed in Japanese Laid-Open Publication 2001-109956. The hand terminal comprises a scanner for optically reading a bar-coded commodity code, a keyboard, a radio communication apparatus, and so on. The hand terminal executes radio communication with the electronic inventory tag through the radio communication apparatus.

Such a conventional electronic inventory tag system, however, has a problem. Since the system requires a receiving apparatus which is used only for radio communication in order to achieve radio communication between the electronic inventory tag and the host machine, the structure becomes complicated.

Accordingly, the object of the present invention is to simplify the structure of the receiving apparatus for data communication, which has a solar battery.

### SUMMARY OF THE INVENTION

According to the present invention, an optical communication system is provided which includes: (i) a transmitting apparatus which includes a light source, and which converts digital data into an optical signal and transmits the optical signal by controlling the light source to fluctuation in accordance with the optical signal, and (ii) a receiving apparatus for receiving the optical signal and converting the optical signal back into the digital data. The receiving apparatus converts optical energy into electrical energy by a solar battery for powering the receiving apparatus, utilizes a fluctuation of generation of electricity of the solar battery, which occurs in accordance with the fluctuation of the light source transmitting the optical signal, as a fluctuation signal, and converts the fluctuation signal into the digital data.

In addition, according to the present invention, a receiving apparatus is provided which converts optical energy into electrical energy with a solar battery for powering the receiving apparatus, utilizes a fluctuation of generation of electricity, which is generated in accordance with an optical pulsing signal received by the solar battery, as the fluctuation signal, and converts the fluctuation signal into digital data.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a structural diagram schematically showing an electronic inventory tag system of an embodiment of the present invention;

FIG. 2 is an elevational view showing the electronic inventory tag;

FIG. 3 is a circuit diagram showing a circuit structure of the electronic inventory tag;

FIG. 4 is a time chart of various voltages of the electronic inventory tag;

FIG. 5 is a perspective view showing a hand terminal;

FIG. 6 is a block diagram showing an electronic installation of the hand terminal;

FIG. 7 is a block diagram showing an electronic installation of a store computer;

FIG. 8 is a flow chart showing a data transmission process of a unit price;

FIG. 9 is a flow chart showing a process of changing of a unit price with respect to the hand terminal;

FIG. 10 is a flow chart showing a data transmission process of a unit price; and

FIG. 11 is a flow chart showing a process of changing a unit price with respect to the electronic inventory tag.

### DETAILED DESCRIPTION OF THE PREFERRED EMBODIMENTS

An embodiment of the present invention will be explained with reference to the drawings. The embodiment of the present invention applies an optical communication system using a solar battery to an electronic inventory tag system used in a store such as a supermarket.

[System Outline]

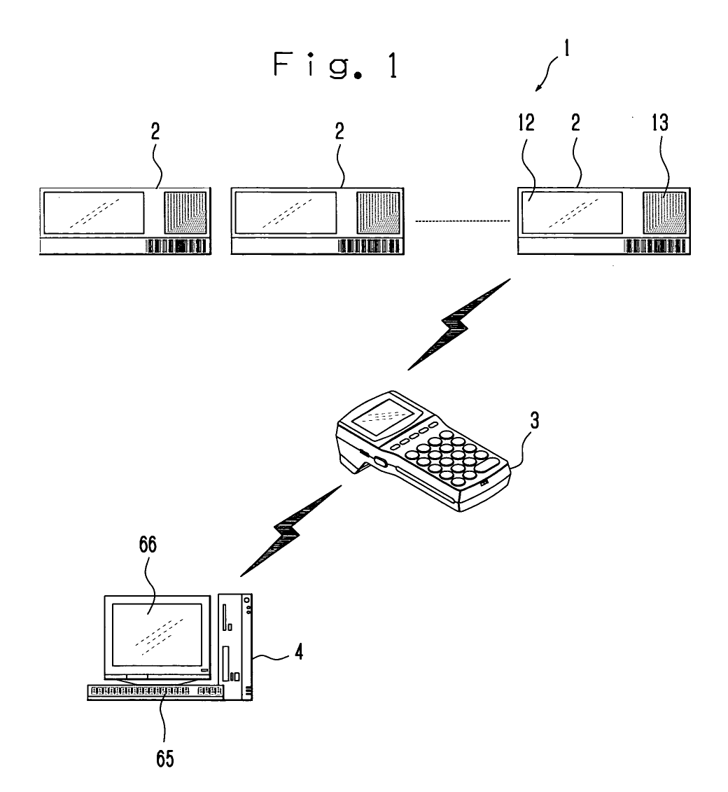

FIG. 1 is a structural diagram schematically showing an electronic inventory tag system 1 of an embodiment of the present invention. As shown in FIG. 1, an electronic inventory tag system 1 comprises a plurality of electronic inventory tags 2 as receiving apparatuses for displaying commodity data such as a commodity price, a hand terminal 3 as a transmitting apparatus for transmitting the commodity data to the electronic inventory tags 2, a store computer 4 as a host machine for delivering the commodity data to the hand terminal 3, and so on. One or more hand terminals 3 can be provided. The electronic inventory tag system 1 executes optical communication between the hand terminal 3 and the electronic inventory tags 2 by use of a change of the amount of electricity generated by a solar battery 13 (explained later) in the electronic inventory tags 2 in accordance with a light emitted from the hand terminal 3.

[Electronic Inventory Tag 2]

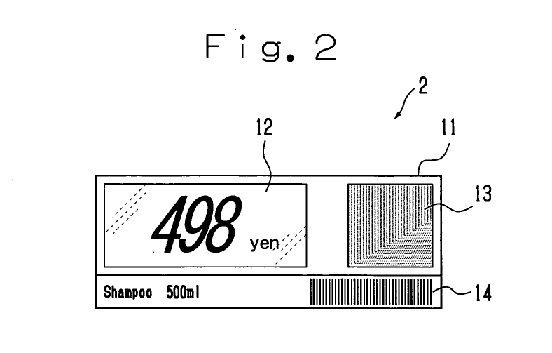

FIG. 2 is an elevational view showing one of the electronic inventory tags 2. The electronic inventory tag 2 is installed at a position of a shelf (not shown) corresponding to a commodity, and displays commodity data such as unit price data of the corresponding commodity. The electronic inventory tag 2 has a rectangular housing 11. The housing 11 contains the solar battery 13, and a liquid crystal display (LCD) 12 as an indicator for displaying the commodity data such as the unit price data. In addition, a commodity data card 14, on which a name of the commodity and a bar-code are printed, is fixed to the housing 11. The bar-code is a bar-coded commodity code. Although the liquid crystal display 12 is used as the indicator in the embodiment of the present invention, a LED display, an EL display, or another display can be applicable. Also, either a monochrome display or a color display can be used.

The solar battery 13 is a power source which converts received optical energy to electrical energy. Since the structure of solar batteries is well-known, a detailed explanation thereof will be omitted. The electronic inventory tag 2 is driven by the electrical energy generated by the solar battery 13; that is, the solar battery 13 produces a drive power of the electronic inventory tag 2.

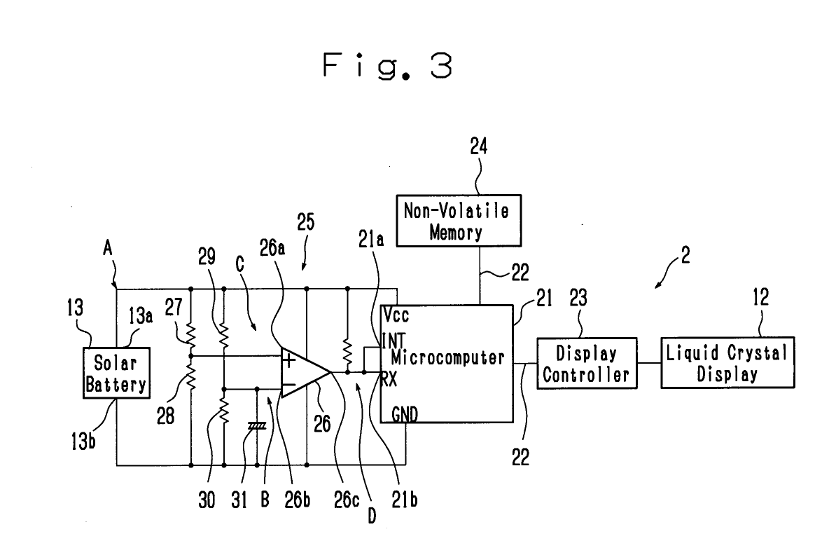

FIG. 3 is a circuit diagram showing a circuit structure of the electronic inventory tag 2. The electronic inventory tag 2 comprises a microcomputer 21 which contains a CPU (Central Processing Unit) for intensively controlling each part, a ROM (Read Only Memory) for storing fixed data, such as computer programs, in advance, and a RAM (Random Access Memory) for rewritably storing various data and for functioning as a working area so that the microcomputer 21 can control each part.

A display controller 23 for driving the liquid crystal display 12 is connected to the microcomputer 21 through a bus line 22. A non-volatile memory 24 comprising a rewritable EEPROM (Electrically Erasable Programmable Read Only Memory) is connected to the microcomputer 21 through the bus line 22. In the non-volatile memory 24, a unit price memory area (not shown) is formed, where data such as a unit price to be displayed in the liquid crystal display 12 is stored as digital data. The display controller 23 receives the digital data such as the unit price stored in the non-volatile memory 24, converts the digital data into data suitable for display, and displays the data in the liquid crystal display 12.

A data receiving circuit 25 connected to the solar battery 13 is connected to the microcomputer 21. When the solar battery 13 receives a plurality of optical pulsing signals, the data receiving circuit 25 utilizes a fluctuation of generation of electricity from the solar battery as a fluctuation signal in accordance with the received optical signal. A comparator 26 is provided in the data receiving circuit 25. A plus input terminal 26a of the comparator 26 is connected to an output terminal 13a of the solar battery 13 through a resistance 27, and is also connected to the other output terminal 13b of the solar battery 13 through a resistance 28. A minus input terminal 26b is connected to an output terminal 13a of the solar battery 13 through a resistance 29, and is also connected to the other output terminal 13b of the solar battery 13 through a resistance 30. An output terminal 26c of the comparator 26 is connected to an interrupt terminal 21a of the microcomputer 21 and to a data receiving terminal 21b.

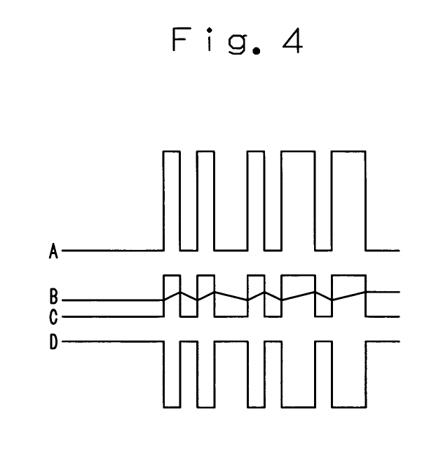

As an amount of light exposed on the solar battery 13 changes so that an amount of electricity generated by the solar battery 13 changes, a voltage in the receiving circuit 25 changes. When a certain amount of light from a lighting installation of a shop (not shown) shines on the solar battery 13, for example, as shown in FIG. 4, so that an optical pulsing signal is emitted to the solar battery 13, an output voltage A (a generated voltage indicated as A in FIG. 3) of the solar battery 13 changes to a pulsing voltage. The output voltage A of the solar battery 13 is divided by the resistances 29 and 30, and is stored in a condenser 31 so that the output voltage A of the solar battery 13 is input as a reference voltage B (indicated as B in FIG. 3) of an analogue signal into the minus input terminal 26b of the comparator 26. At this time, a voltage C (indicated as C in FIG. 3), which is a divided voltage of the output voltage A by the resistances 27 and 28, is input as a pulsing analogue signal into the plus input terminal 26a of the comparator 26. Then, these input voltages B and C (the analogue signals) are compared in the comparator 26 and a fluctuation of the output voltage A is output into the microcomputer 21 as a pulse of voltage D (a digital signal indicated D in FIG. 3). The pulse of voltage D output by the comparator 26 is the fluctuation signal explained earlier. The microcomputer 21 stores the pulse of voltage D as digital data, that is, a data row of a combination of ┌1┘ and ┌0┘.

[Hand Terminal 3]

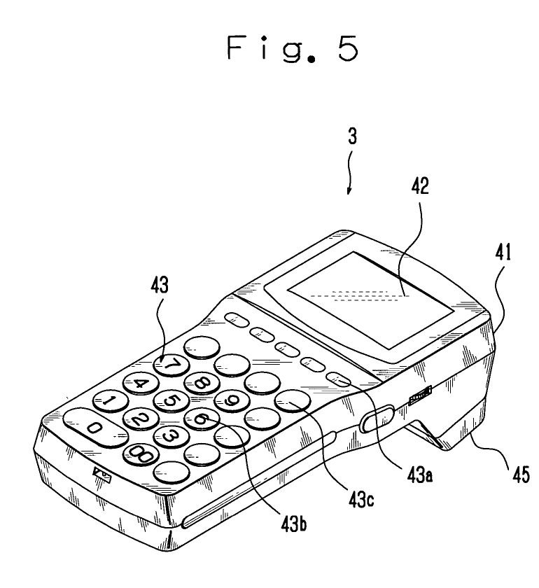

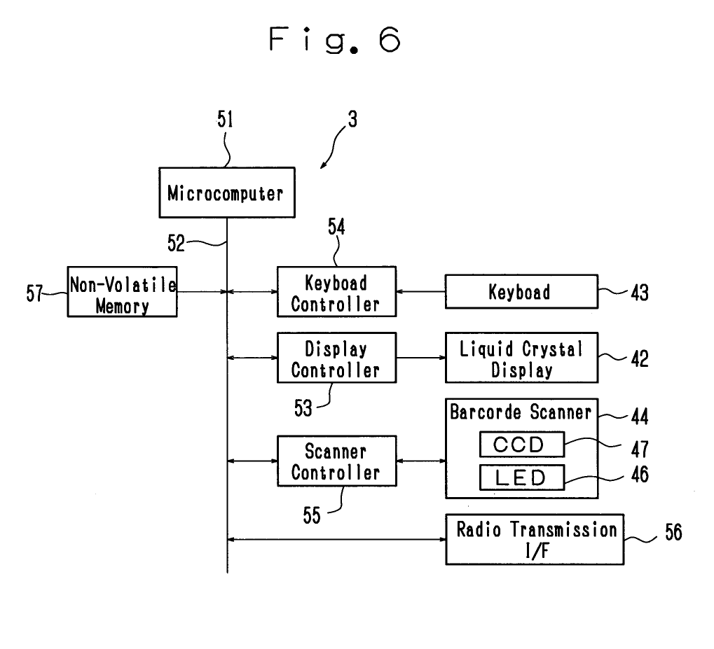

FIG. 5 is a perspective view showing a hand terminal 3. As shown in FIG. 5, a liquid crystal display 42 and a key board 43 are provided on an upper surface of a body case 41. The key board 43 comprises function keys 43a, numeric keypads 43b, transmission keys 43c and so on. A barcode scanner 44 as an optical reading apparatus is provided in the body case 41 and a barcode reading window 45 is formed under the body case 41. The barcode scanner 44 comprises a LED (Light Emitting Diode) array 46 (see FIG. 6) to emit a light to a barcode from the LED array, and reads a reflected light received by a CCD 47 (Charge Coupled Device, see FIG. 6). The hand terminal 3 is made to be portable.

FIG. 6 is a block diagram showing an electronic installation of the hand terminal 3. The hand terminal 3 comprises a microcomputer 51 which contains a CPU for intensively controlling each part, a ROM for storing fixed data such as computer programs, in advance, and a RAM for rewritably storing various data, and for functioning as a working area, so that the microcomputer 51 controls each part.

A display controller 53 for driving the liquid crystal display 42, a keyboard controller 54 for outputting a signal from the key board 43, a scanner controller 55 for driving the CCD 47 and the LED array 46, and so on, are connected to the microcomputer 51 through a bus line 52. Further, a radio transmission interface 56 for executing radio communication with a store computer 4, a non-volatile memory 57 comprising a rewritable EEPROM, and so on, are connected to the microcomputer 51 through a bus line 52. In the non-volatile memory 57, for example, a commodity master file (as explained later), which is delivered from the store computer 4, is stored.

[Store Computer 4]

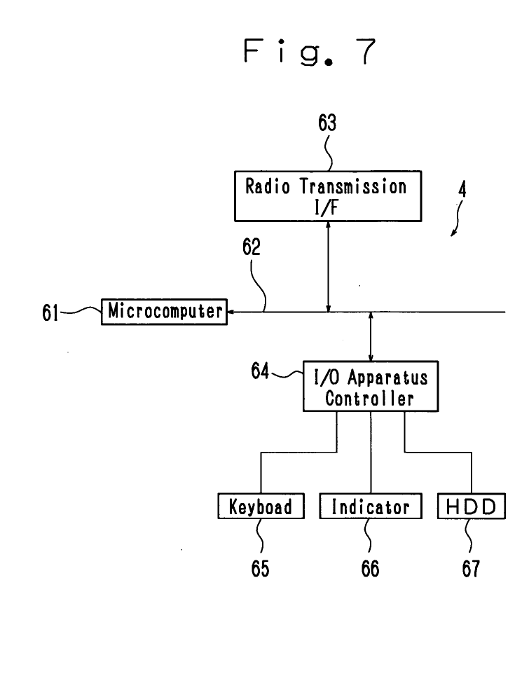

FIG. 7 is a block diagram showing an electronic installation of a store computer 4. The store computer 4 has a microcomputer 61 comprising a CPU, a ROM, a RAM, and so on, so as to execute radio communication between the hand terminal 3 and a radio transmission interface 63 connected to the microcomputer 61 through a bus line 62.

A key board 65, an indicator 66, and a HHD (Hard Disk Drive) 67 are connected to the microcomputer 61 through the bus line 62 and an I/O apparatus controller 64. The HHD 67 stores a program for controlling the CPU of the microcomputer 61, the commodity master file, and so on. The commodity master file stores a commodity code corresponding to commodity data such as a name of the commodity and a unit price.

[Various Processing]

Various processing executed by the microcomputers 21, 51, and 61 of an electronic inventory tag system 1 in accordance with computer programs will be explained with an operation procedure by a shop assistant.

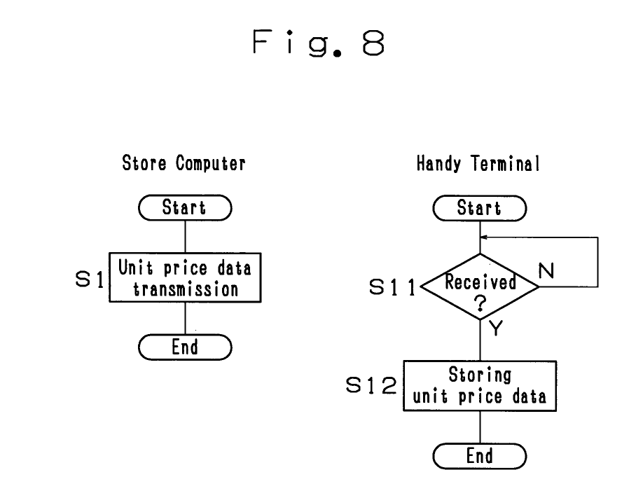

FIG. 8 is a flow chart showing a data transmission process of a unit price.

To change a unit price displayed in the liquid crystal display 12 of the electronic inventory tag 2, the shop assistant changes price data of the commodity master file stored in the HDD 67 by operating the keyboard 65 at the store computer 4, and then a delivering operation of the unit price data is executed.

As shown in FIG. 8, if the delivering operation of the price data is executed by the shop assistant, the commodity master file containing the unit price data stored in the HHD 67 is transmitted to the hand terminal 3 (step S1) via the radio transmission interface 63.

If the commodity master file from the store computer 4 is received in the hand terminal 3 (Y of step S11), the commodity master file is stored in the non-volatile memory 57 (step S12). At this time, if a commodity master file already stored in the non-volatile memory 57, the already stored master file is overwritten by the received master file. Thus, the unit price data of the commodity is delivered from the store computer 4 to the hand terminal 3.

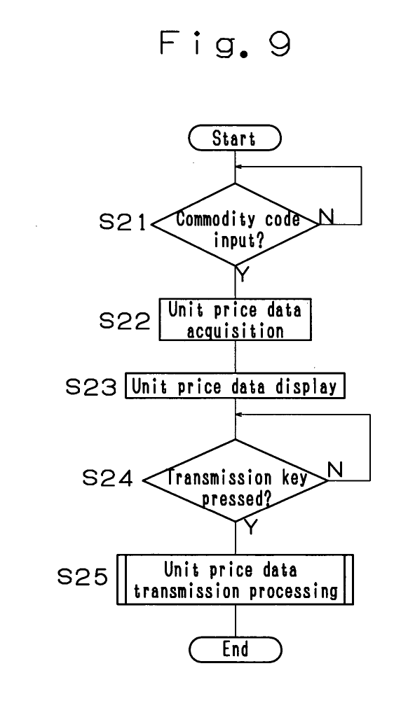

FIG. 9 is a flow chart showing a process of changing a unit price with respect to the hand terminal 3.

Next, the shop assistant uses the hand terminal 3 to execute, with the barcode scanner 44, a scanning operation of a barcode printed on the commodity data card 14 of the electronic inventory tag 2.

As shown in FIG. 9, if the commodity code is read and output by the barcode scanner 44 operated by the shop assistant (Y of step S21), the commodity master file stored in the non-volatile memory 57 is searched and the unit price data of the commodity and so on are acquired (step S22). Then, the acquired unit price data and so on are displayed in the liquid crystal display 42 (step S23).

After the shop assistant confirms the unit price data and so on displayed in the liquid crystal display 42, he/she places the hand terminal 3 close to the electronic inventory tag 2 so as to expose the solar battery 13 of the electronic inventory tag 2 to a light emitted from the LED array 46 of the barcode scanner 44. Then, he/she presses the transmission key(s) 43c on the keyboard 43.

If the transmission key(s) 43c on the keyboard 43 is/are pressed by the shop assistant (Y of step S24), a unit price data transmission process is executed to transmit the commodity unit price data to the electronic inventory tag 2 by optical communication (step S25).

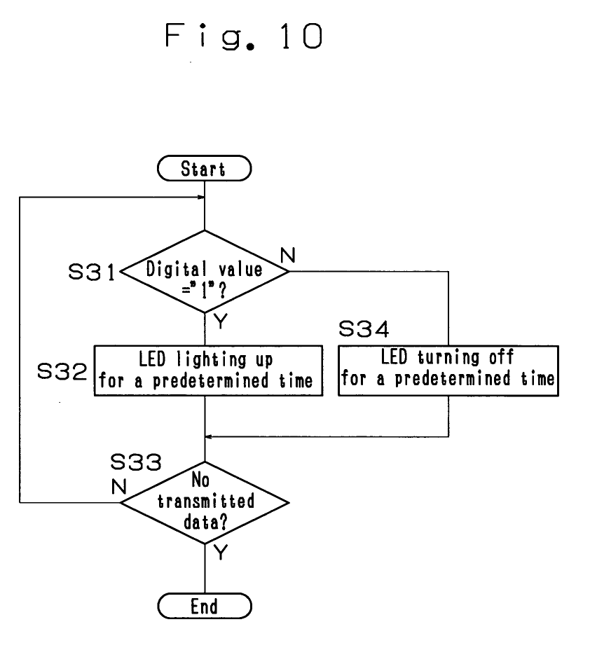

The unit price transmission process in step S25 will be explained with reference to FIG. 10. As shown in FIG. 10, lighting of the LED array 46 is controlled in accordance with a digital value which makes up the digital commodity code acquired in step S22. To be specific, since the digital data consists of a data row of digital values (┌1┘ and ┌0┘), the lightning is executed in accordance with the first digital value of the data row, and then is executed in accordance with the following digital value. If the digital value is ┌0┘ (Y of step S31), the LED array 46 lights up for a predetermined time (step S32)). If the digital value is ┌0┘, instead of ┌1┘ (N of step S31), the LED array 46 turns off for a predetermined time (step S34). If the digital data is not the last one in the data row and data still remains (N of step S33), the process goes back to step S31, and is executed with respect to a next digital value of the data row. The digital commodity code is thus converted into an optical pulsing signal by lightning up or turning off of the LED array 46 with respect to each digital value, and the optical pulsing signal is transmitted to the electronic inventory tag 2.

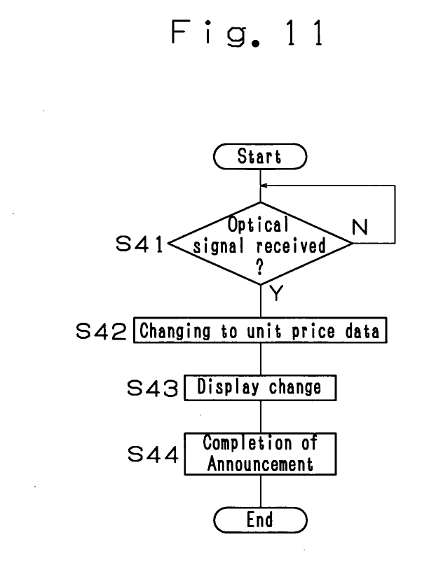

FIG. 11 is a flow chart showing a process of changing a unit price with respect to the electronic inventory tag 2.

If the electronic inventory tag 2 receives the optical pulsing signal from the hand terminal 3 (Y of step S41), the optical pulsing signal is converted back into the original digital unit price data, and is stored in a unit price memory area of the non-volatile memory 24 (step S42). If a unit price data is already stored in the unit price memory area, the already stored unit price data is overwritten by the received unit price data. Since a converting method of an optical pulsing signal into digital data is already explained, a detailed explanation thereof will be omitted.

Then, the unit price data stored in the unit price memory area is displayed in the liquid crystal display 12 (step S 43), and the unit price data flashes a predetermined number of times (step S44) in order to generate a notification of a successful receipt of the optical pulsing signal and a completion of data conversion. When the flashing is over, the display returns to normal.

As explained above, according to the embodiment of the present invention, the commodity data is digital data, and the electronic inventory tag 2 is a receiving apparatus that includes the liquid crystal display 12 as an indicator for displaying information, and the microcomputer 21 and display controller 23 which act as a display control section for displaying the commodity data on the liquid crystal display 12 in accordance with the digital data converted from the optical signal. In addition, since the electronic inventory tag 2 having the solar battery 13 as a driving source executes the optical transmission by receiving the optical signal from the hand terminal 3 as a transmitting apparatus, a structure for data transmission of the electronic inventory tag 2 can be simplified compared to a conventional receiving apparatus which requires a radio communication apparatus used for data transmission only.

Further, according to the embodiment of the present invention, the transmitting apparatus (hand terminal 3) comprises: the LED array 46 as a light source and the barcode scanner 44 as an optical reading apparatus for reading the commodity code by use of a reflection of a light emitted by the LED array 46 toward the bar-coded commodity code, the non-volatile memory 57 as a memory for storing the digital commodity code corresponding to the commodity data, and the microcomputer 51 which acts as a control unit and acquires the commodity data stored in the non-volatile memory 57 corresponding to the commodity code which is read by the barcode scanner 44, converts the acquired commodity data (the unit price data in the embodiment of the present invention) into the optical signal, and transmits the optical signal. In addition, the hand terminal 3 transmits the optical signal to the electronic inventory tag 2 as the receiving apparatus by optical communication by using the LED array 46 contained in the barcode scanner 44. The LED array 46 is thus used as the light source of the optical communication as well as the light source for the barcode scanner 44. Thus, the structure of the hand terminal 3 can be simplified compared to a conventional transmitting apparatus which requires a radio communication apparatus used only for transmission.

Still further, according to the embodiment of the present invention, the store computer 4 serves as a host machine for storing the commodity code corresponding to the commodity data, and transmits the data to the radio transmission interface 56 of the hand terminal 3 through the radio transmission interface 63 (the radio interfaces 56 and 63 being means for enabling data communication between the hand terminal 3 as the transmission means capable of data-transmission between the hand terminal 3 as the transmitting apparatus and the store computer 4, the hand terminal 3 stores the commodity data in the non-volatile memory 57, in correspondence with the commodity code received from the store computer 4 by data transmission. With this structure, data stored in a plurality of hand terminals 3 can be changed all together by data transmission from the single store computer 4.

Yet still further, according to the embodiment of the present invention, since the electronic inventory tag 2 generates a notification of the receipt of the optical signal, the operator (the shop assistant) can confirm the completion of data transmission.

The embodiment of the present invention is described in conjunction with a specific example of the optical communication system using the solar battery 13 in which the electronic inventory tag 2 as the receiving apparatus is applied to the electronic inventory tag system 1, but the present invention is not limited to this example. The present invention can be applied to any system having a combination of a receiving apparatus using solar power and a transmitting apparatus having a light source.

Obviously, numerous modifications and variations of the present invention are possible in light of the above teachings. It is therefore to be understood that within the scope of the appended claims, the invention may be practiced otherwise than as specifically described herein.

What is claimed is:

1. An optical communication system, comprising:
a transmitting apparatus which comprises a light source, and which converts digital data into an optical signal and transmits the optical signal by controlling the light source; and
a receiving apparatus for receiving the optical signal and converting the optical signal back into the digital data;
Wherein the receiving apparatus comprises:
a solar battery which powers the receiving apparatus by converting optical energy into electrical energy, and which receives the optical signal from the transmitting apparatus such that generation of electricity by the solar battery fluctuates in accordance with the optical signal;
a circuit for utilizing the fluctuation of the generation of electricity by the solar battery as a fluctuation signal; and
control section which converts the fluctuation signal into the digital data.

2. The optical communication system according to claim 1,
wherein the digital data comprises commodity data; and,
wherein the receiving apparatus comprises an electronic inventory tag which includes an indicator for displaying information, and a display control section for causing the indicator to display the commodity data in accordance with the digital data converted from the fluctuation signal.

3. The optical communication system according to claim 2,
wherein the transmitting apparatus further comprises:
an optical reading apparatus which reads a bar-coded commodity code as commodity code data based on a reflection of light emitted from the light source to the bar-coded commodity code;
a memory unit for storing the commodity data corresponding to the commodity code data; and
control section which acquires the commodity data stored in the memory unit in accordance with the commodity code data read by the optical reading apparatus,
wherein the transmitting apparatus converts the acquired commodity data into the optical signal and transmits the optical signal.

4. The optical communication system according to claim 3, further comprising:
a host machine for storing the commodity data corresponding to the commodity code data;
means for enabling data communication between the host machine and the transmitting apparatus to transmit the commodity data and the commodity code data from the host machine to the transmitting apparatus.

5. The optical communication system according to claim 1, wherein the receiving apparatus generates a notification of completion of receipt of the optical signal.

6. The optical communication system according to claim 2, wherein the receiving apparatus generates a notification of completion of receipt of the optical signal.

7. The optical communication system according to claim 3, wherein the receiving apparatus generates a notification of completion of receipt of the optical signal.

8. The optical communication system according to claim 4, wherein the receiving apparatus generates a notification of completion of receipt of the optical signal.

9. An apparatus comprising:
a solar battery which powers the receiving apparatus by converting optical energy into electrical energy, and which receives an optical pulsing signal such that generation of electricity by the solar battery fluctuations in accordance with the optical pulsing signal;
a circuit for utilizing the fluctuation of the generation of electricity by the solar battery as a fluctuation signal; and a control section which converts the fluctuation signal into digital data.
